(19) United States
(12) Patent Application Publication
(10) Pub. No.: US 2013/0164014 A1
(43) Pub. Date: Jun. 27, 2013

(54) MEDIA STORAGE DEVICE AND SECTIONAL IMAGE PRINTING METHOD

(71) Applicants: Chih-Hwa Wang, New Taipei City (TW); Ju-Chou Chen, New Taipei City (TW)

(72) Inventors: Chih-Hwa Wang, New Taipei City (TW); Ju-Chou Chen, New Taipei City (TW)

(73) Assignees: Kinpo Electronics, Inc., New Taipei City (TW); Cal-Comp Electronics & Communications Company Limited, New Taipei City (TW)

(21) Appl. No.: 13/412,638

(22) Filed: Mar. 6, 2012

(30) Foreign Application Priority Data
Dec. 21, 2011 (TW) 100147769

(51) Int. Cl. G03G 15/20

(52) U.S. Cl. 399/69

(57) ABSTRACT

A media storage device and a sectional image printing method are provided. The media storage device includes a main body, a sectional heating module and a pressing roller. The sectional heating module and the pressing roller are both disposed within the main body. The sectional heating module includes a body, a plurality of heaters and a power controller. The body is disposed within the main body, and the heaters are disposed on the body. The power controller includes a plurality of power circuits, and each of the power circuits is electrically connected with a corresponding one of the heaters to control the corresponding electrically connected heater to generate heat. The pressing roller is in contact with the heaters of the sectional heating module, and the heaters face the pressing roller. During a printing process, not all the heaters of the media storage device generate heat at the same time.

### CROSS-REFERENCE TO RELATED APPLICATION

This application claims the priority benefit of Taiwan application serial no. 100147769, filed on Dec. 21, 2011. The entirety of the above-mentioned patent application is hereby incorporated by reference herein and made a part of this specification.

### BACKGROUND OF THE INVENTION

1. Field of the Invention

The present invention relates to an office machine and a method, and more particularly, to a media storage device and a sectional image printing method.

2. Description of Related Art

With the coming of information society, offices are equipped with various office automation equipments such as scanners, photocopiers or printers. Users can employ these office automation equipments for word processing work. However, the above various automation equipments equipped in the office at the same time would occupy a large space in the office. Therefore, a media storage device which integrates the photocopy, print and scan function has been developed to address the space occupation issue.

For example, the media storage device can include a print apparatus and a scan apparatus. The print apparatus includes a heater that can generate heat to cause the toner to be fixed onto paper during a printing process of the media storage device.

However, a printed image or text is usually not distributed over the entire paper, i.e. there are white space portions on the printed paper. In the conventional media storage device, the length of the heater usually corresponds to the width of the paper. During the printing process, the entire heater generates heat and moves along a length direction of the paper, regardless whether the image is distributed over the entire width of the paper. Accordingly, a considerable amount of power is required to cause the entire heater to generate heat.

### SUMMARY OF THE INVENTION

Accordingly, the present invention is directed to a media storage device which includes a plurality of heaters and in which only those heaters that are positioned in correspondence with the image generate heat thus saving the energy.

The present invention is also directed to a sectional image printing method in which only those heaters that are positioned in correspondence with the image generate heat to achieve the energy-saving result.

The present invention provides a media storage device including a main body, a sectional heating module and a pressing roller. The sectional heating module and the pressing roller are both disposed within the main body. The sectional heating module includes a body, a plurality of heaters and a power controller. The body is disposed within the main body, and the heaters are disposed on the body. The power controller includes a plurality of power circuits, and each of the power circuits is electrically connected with a corresponding one of the heaters to control the corresponding electrically connected heater to generate heat. The pressing roller is in contact with the heaters of the sectional heating module, and the heaters face the pressing roller. During a printing process, not all the heaters of the media storage device generate heat at the same time.

In one embodiment, the heaters are ceramic heaters.

In one embodiment, the sectional heating module further includes a sleeve, and the body and the heaters are disposed in the sleeve. Two ends of the body may or may not protrude out of the sleeve.

In one embodiment, the sleeve includes a surface layer, a buffer layer and a base layer. The buffer layer is disposed between the surface layer and the base layer. The base layer is closer to the body and the heaters, and the surface layer is closer to the pressing roller.

In one embodiment, the heating resolution of the sectional heating module includes 200 dpi, 300 dpi, 600 dpi and 1200 dpi.

The present invention additionally provides a sectional image printing method. In this method, a sectional heating module and a pressing roller in contact with the sectional heating module is provided. An image is formed on a piece of paper in advance. The paper is caused to pass through between the pressing roller and the sectional heating module. Multiple heaters of the sectional heating module that are positioned in correspondence with the image are caused to generate heat. The pressing roller and the sectional heating module are caused to press against each other so that the image is fixed onto the paper.

In one embodiment, any two adjacent ones of the heaters do not generate heat.

In one embodiment, any two adjacent ones of the heaters generate heat.

In one embodiment, one of any two adjacent ones of the heaters generates heat.

In one embodiment, causing the multiple heaters of the sectional heating module that are positioned in correspondence with the image to generate heat is conducted in such a manner that the heaters are each controlled by a corresponding power circuit.

In one embodiment, the number of the heaters is determined based on a paper print resolution.

In summary, in the media storage device and sectional image printing method of the present invention, during a printing process, not all the heaters of the sectional heating module generate heat at the same time. Instead, only those heaters that are positioned in correspondence with the image on the paper generate heat, thereby effectively saving the energy.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 illustrates a media storage device according to one embodiment of the present invention.

FIG. 2 a partial, exploded view of a sectional heating module of the media storage device of FIG. 1.

FIG. 3 is a block diagram illustrating the electrical connection between a power controller and heaters of the sectional heating module of FIG. 2.

FIG. 4 is a view illustrating paper passing the sectional heating module and pressing roller of the media storage device of FIG. 1.

FIG. 5 is a front view of FIG. 4, viewed from an axial direction A of the pressing roller of FIG. 4.

FIG. 6A illustrates an unfixed image formed on the paper by the toner.

FIG. 6B illustrates a sequence of the heating of the heaters to fix the toner of FIG. 6A onto the paper.

FIG. 7A is a block diagram of the media storage device.

FIG. 7B is a sequence of the heating of the sectional heating module of the media storage device of FIG. 7A.

### DESCRIPTION OF THE EMBODIMENTS

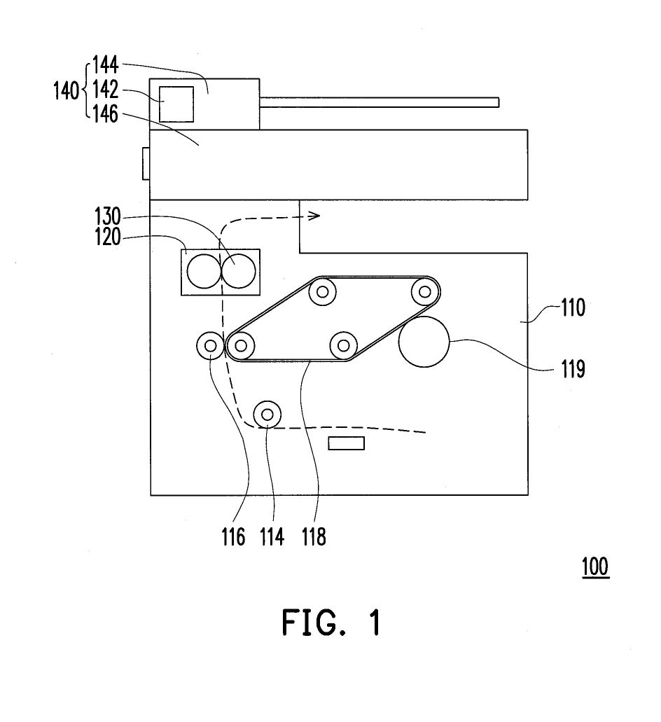

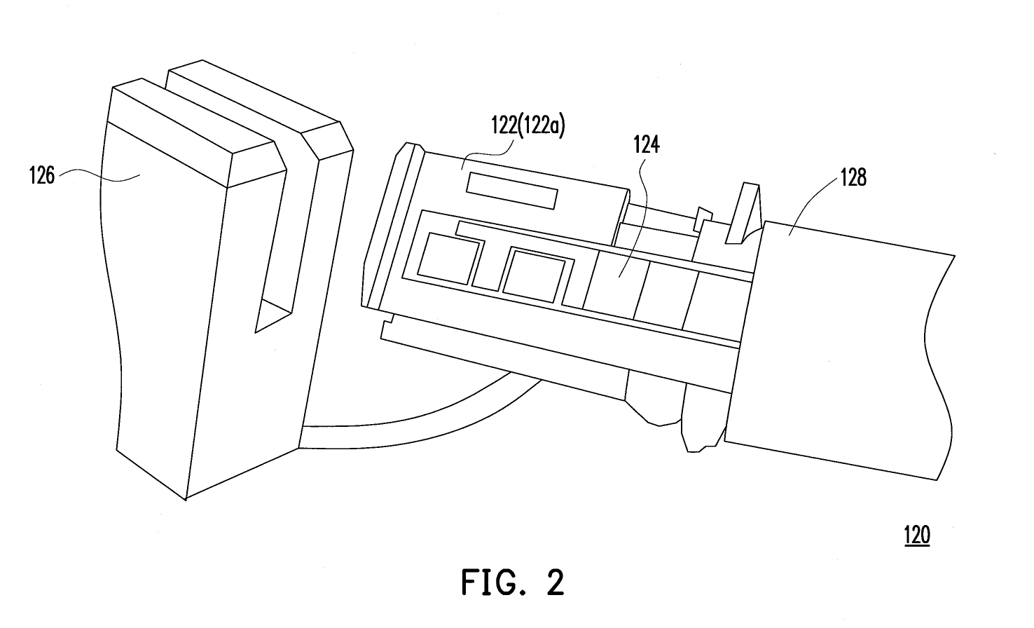

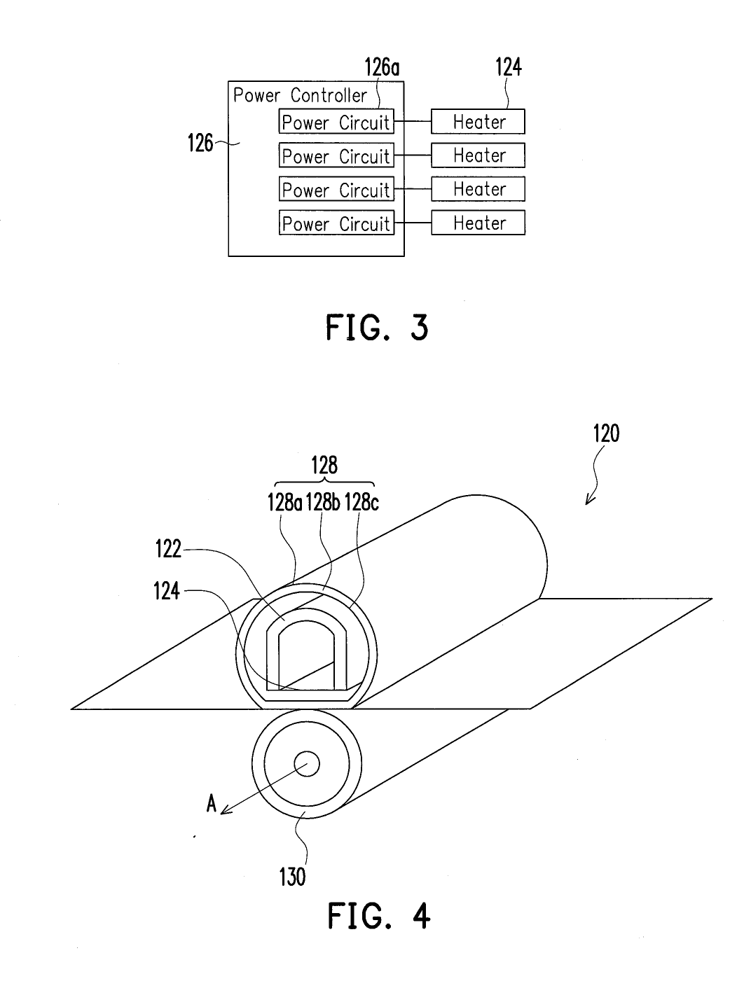

FIG. 1 illustrates a media storage device according to one embodiment of the present invention. FIG. 2 is a partial, exploded view of a sectional heating module of the media storage device of FIG. 1. FIG. 3 is a block diagram illustrating the electrical connection between a power controller and heaters of the sectional heating module of FIG. 2. Referring to FIG. 1, FIG. 2 and FIG. 3, the media storage device 100 of the present embodiment includes a main body 110, a sectional heating module 120 and a pressing roller 130. The sectional heating module 120 and the pressing roller 130 are both disposed within the main body 110. The sectional heating module 120 includes a body 122, a plurality of heaters 124 and a power controller 126. The body 122 is disposed within the main body 110, and the heaters 124 are disposed on the body 122. The power controller 126 includes a plurality of power circuits 126a, each power circuit 126a is electrically connected to a corresponding one of the heaters 124 and, as such, each power circuit 126a controls the corresponding one of the heaters 124 which is electrically connected to the power circuit 126a to heat. The pressing roller 130 contacts the heaters 124 of the sectional heating module 120, and the heaters 124 face the pressing roller 130.

The heaters 124 are ceramic heaters which generate heat using resistors. The sectional heating module 120 further includes a sleeve 128, and two ends of the body 122 (only one end 122a is illustrated in FIG. 2) may or may not protrude out of the sleeve 128. The power controller 126 of the present embodiment is disposed on the end 122a of the body 122. The location of the power controller 126 may vary according to actual requirements. The power controller 126 may simply be a connector or a controller depending upon actual requirements.

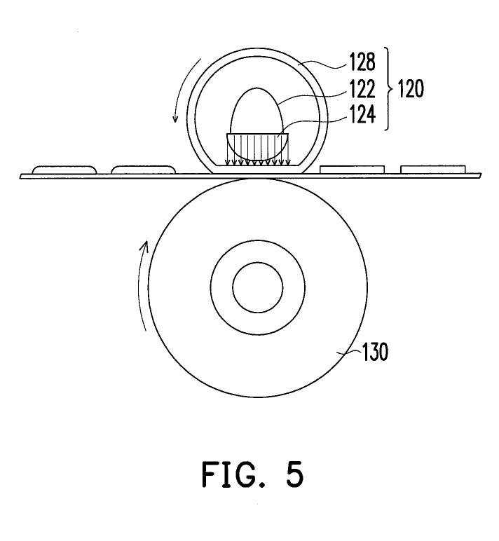

FIG. 4 is a view illustrating paper passing through between the sectional heating module and pressing roller of the media storage device of FIG. 1. Referring to FIG. 4, the sleeve 128 includes a surface layer 128a, a buffer layer 128b, and a base layer 128c. The buffer layer 128b is disposed between the surface layer 128a and the base layer 128c, the base layer 128c is closer to the body 122 and heaters 124, and the surface layer 128a is closer to the pressing roller 130. The buffer layer 128b has elasticity such that, when the pressing roller 130 presses the sleeve 128, the buffer layer 128b deforms slightly under the pressure of the pressing roller 130. The surface layer 128a is very thin or also has elasticity and, therefore, deforms along with the buffer layer 128b, such that the sleeve 128 and the pressing roller 130 are closely contacted with each other. In another embodiment, the sleeve 128 may also be made from a thin heat-resistant resin which can deform under pressure to be in close contact with the ceramic heaters because it is very thin. The body 122 is forced by a spring (not shown), such that the sectional heating module 120 is forced to be in contact with the pressing roller 130 tightly. In addition, the material of the pressing roller 130 is rubber. As such, the pressing roller 130 can deform under pressure to form an area for applying the heat and pressure to fix toner onto the paper.

As shown in FIG. 1, the media storage device 100 further includes other components, such as, a scan apparatus 140 mounted on the main body 110 and including a motor 142, a paper feeding module 144 and a scan module 146, a pick-up roller 114, a transfer roller 116, a transfer belt 118 and a drum 119. These components are well known in the art and explanation thereof is not repeated herein.

A sectional image printing method performed by the media storage device according to the present embodiment is discussed below.

Referring to FIG. 1, when the media storage device 100 of the present embodiment is used to print, the pick-up roller 114 feeds a piece of paper and, at the same time, the transfer belt 118 operates in cooperation with the drum 119 to cause toner to be adhered to the transfer belt 118. When the paper passes through between the transfer belt 118 and the transfer roller 116, the toner is adhered to the paper to form an image on the paper.

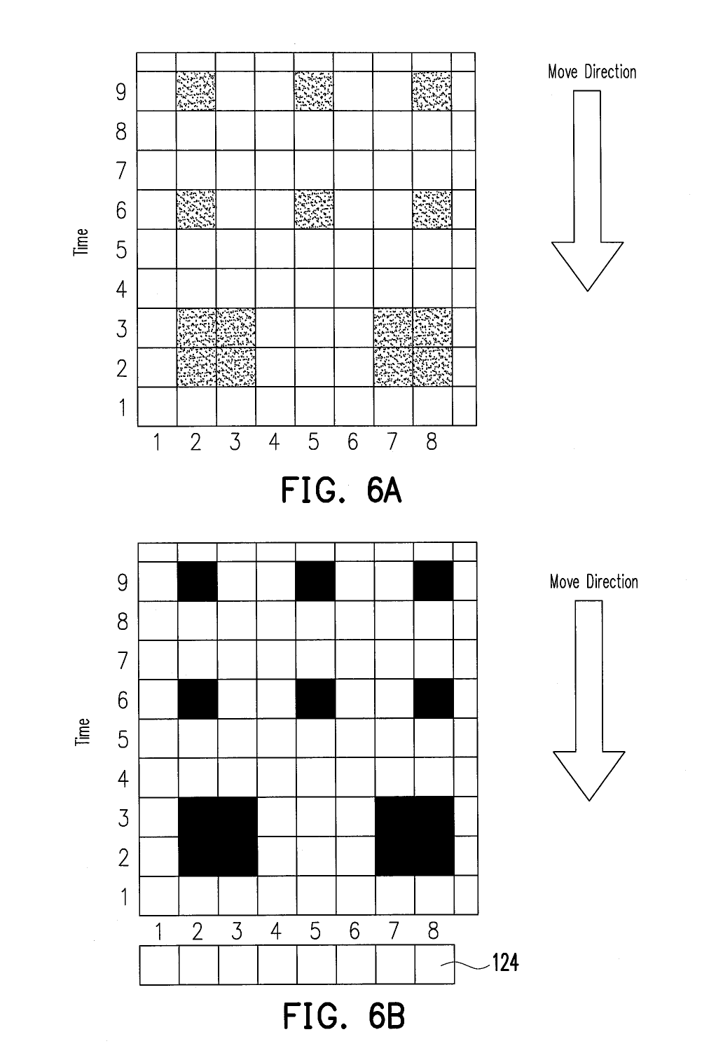

FIG. 5 is a front view of FIG. 4, viewed from an axial direction A of the pressing roller of FIG. 4. Referring to FIG. 1, FIG. 4, and FIG. 5, the paper then passes through between the sectional heating module 120 and the pressing roller 130, such that the toner and hence the image is fixed onto the paper under the heating of the heating module 120 and the pressing of the pressing roller 130. The toner at the left side of FIG. 5 that has a slightly rounded edge is unfixed toner, and the toner having a rectangular shape at the right side of FIG. 5 is toner fixed onto the paper that has undergone the heating and pressing of the sectional heating module 120 and the pressing roller 130.

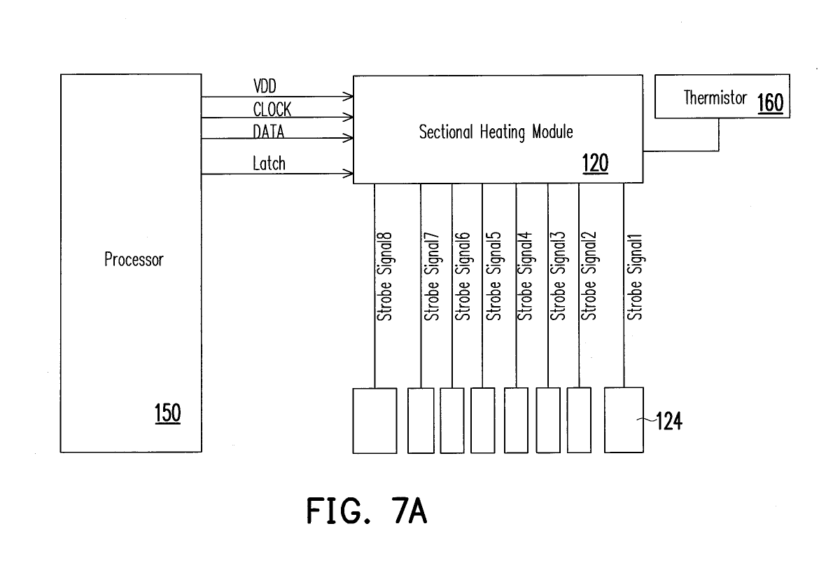

FIG. 6A illustrates an unfixed image formed on the paper by the toner. FIG. 6B illustrates a sequence of the heating of the heaters to fix the toner of FIG. 6A onto the paper. Referring to FIG. 4, FIG. 6A and FIG. 6B, in the present embodiment, eight heaters 124 are disposed on the body 122 of the sectional heating module 120 and, accordingly, the power controller 126 includes eight individual power circuits 126a electrically connected to the heaters 124, respectively. As such, when printing an image onto the paper, the paper is divided into seventy two sections arranged in eight columns and nine rows, and each heater 124 is controlled by a corresponding one of the power circuits 126a of the power controller 126 (as shown in FIG. 3). It is noted, however, that the use of eight heaters 124 and eight power circuits 126a herein is for the purposes of illustration only and that the number of the heaters 124 and power circuits 126a may vary according to actual requirements. For example, the number of the heaters 124 and power circuits 126a may be determined based on the paper print resolution, or the resolution of the heating of the sectional heating module 120. In other embodiments, the heating resolution of the sectional heating module 120 may range between 200 to 1200 dots per inch (dpi), for example, 200 dpi, 300 dpi, 600 dpi and 1200 dpi.

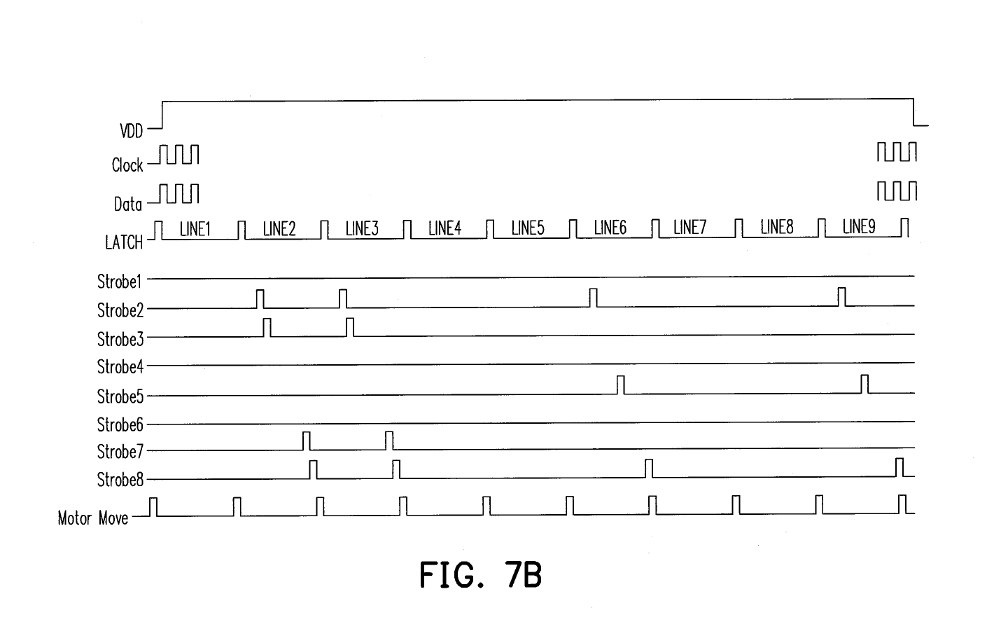

The media storage device as constructed above needs to operate in cooperation with a circuit. FIG. 7A is a block diagram of the media storage device. FIG. 7B illustrates a sequence of the heating of the sectional heating module of the media storage device of FIG. 7A. Referring to FIG. 7A and FIG. 7B, a processor 150 is disposed in the main body 110 and is electrically connected with the sectional heating module 120. In addition, a protective circuit 160 is electrically connected with the sectional heating module 120 to protect the sectional heating module 120. In brief, when a work voltage VDD is supplied to the sectional heating module 120 under the control of the processor 150, the processor 150 further provides a sequence signal CLOCK, data DATA and a latch signal LATCH to the sectional heating module 120 at the same time. The sectional heating module 120 then triggers a corresponding heater 124 according to a strobe signal STROBE provided by the processor 150.

Referring to FIG. 6A, FIG. 6B, FIG. 7A and FIG. 7B, assuming it takes one second to fix the toner onto each row of the paper, when the paper enters between the sectional heating module 120 and the pressing roller 130, no toner is adhered to the first row of the paper. As such, at the time of the first second, none of the eight heaters 124 is driven to generate heat (represented as white sections in FIG. 6B). With the second row of the paper enters between the sectional heating module 120 and the pressing roller 130, because there is toner adhered to the second, third, seventh and eighth sections, at the time of the second second, the processor 150 transmits signal to the sectional heating module 120 to trigger the number 2, number 3, number 7 and number 8 heaters 124 to be driven to generate heat (represented as black sections in FIG. 6B) to a desired temperature, and the pressing roller 130 presses the sleeve 128 at the same time, such that the toner is fixed onto the paper under the pressure and heat. Likewise, when the third row of the paper enters between the sectional heating module 120 and the pressing roller 130, because there is toner adhered to the second, third, seventh and eighth sections of the third row, at the time of the third second, the number 2, number 3, number 7 and number 8 heaters 124 are driven to generate heat to a desired temperature accordingly, and the pressing roller 130 applies the pressure to fix the toner onto the paper.

By analogy, when the fourth and fifth rows of the paper enter between the sectional heating module 120 and the pressing roller 130, respectively, no toner is adhered to any section of the fourth and fifth rows. Therefore, at the time of the fourth or fifth second, none of the heaters 124 is driven to generate heat. When the sixth row of the paper enters between the sectional heating module 120 and the pressing roller 130, because there is toner adhered to the second, fifth and eighth sections of the sixth row, at the time of the sixth second, the number 2, number 5 and number 8 heaters 124 are driven to generate heat accordingly, and at the same time, the pressing roller 130 applies the pressure to fix the toner onto the paper. The heaters 124 can be driven for the remaining seventh to ninth rows of the paper in the similar manner as those described above and, therefore, explanation thereof is not repeated herein. The conventional heating module includes only one heater corresponding to an entire row along a width direction of the paper, and the entire heater does not discriminate between a to-be-fixed section and a white space section. As a result, the entire heater is driven to generate heat during the printing process and, accordingly, the power controller needs to provide a relative large power to the heater, and the power controller does not stop providing the large power unless the whole paper completely passes through the heater and the pressing roller and the printing process ends. Therefore, the conventional heating module consumes a large amount of energy. In contrast, in the media storage device and the sectional image printing method of the present embodiment, in fixing the toner onto the paper, not all the heaters generates heat at the same time. Rather, the construction and its associated circuit are varied such that only those heaters that are positioned in correspondence with the toner on the paper are driven to generate heat, and the heaters that are positioned in correspondence with the white space sections on the paper, where no toner is adhered, are not driven to generate heat. As such, the present media storage device and sectional image printing method is energy-saving.

In addition, the heaters are preheated for a certain period of time before the toner reaches the toner-fixing region; likewise, the power to the heaters is cut off after a certain period of time lapses after the toner leaves the toner-fixing region, to make sure the toner is fixed. Further, considering the paper skew, heating sections of the heaters 124 need to be enlarged properly to ensure the toner fixing quality.

In summary, in the media storage device and sectional image printing method of the present invention, the paper onto which the toner is to be fixed is divided into multiple sections. The media storage device includes heaters that are equal to the sections along the width direction of the paper in quantity. In fixing the toner onto the paper, only those heaters that are positioned in correspondence with the toner on the paper are driven to generate heat, and the heaters that are positioned in correspondence with white space sections on the paper, where no toner is adhered, are not driven to generate heat. In brief, not all the heaters generate heat at the same time. Instead, only part of the heaters is driven to generate heat. Relatively lower power is provided to these heaters that need to generate heat, thereby effectively saving the energy.

Further, each single heater is driven by a corresponding power circuit. The heaters used in the present invention have a smaller size in comparison with the prior heater. Therefore, provided a same amount of power is received from the power circuit, the smaller heater used in the present media storage device and sectional image printing method can be more rapidly heated to a preset temperature and therefore has a faster heating speed in comparison with the conventional larger heater.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A media storage device comprising:
a main body;
a sectional heating module comprising:
a body disposed within the main body;
a plurality of heaters disposed on the body;
a power controller comprising a plurality of power circuits, each of the power circuits electrically connected with a corresponding one of the heaters to control the corresponding electrically connected heater to generate heat; and
a pressing roller disposed in the body and in contact with the heaters of the sectional heating module, and the heaters facing the pressing roller;
wherein during a printing process, not all the heaters generate heat at the same time.

2. The media storage device according to claim 1, wherein the heaters are ceramic heaters.

3. The media storage device according to claim 1, wherein the sectional heating module further comprises a sleeve, and the body and the heaters are disposed in the sleeve.

4. The media storage device according to claim 3, wherein two ends of the body protrude out of the sleeve.

5. The media storage device according to claim 3, wherein two ends of the body do not protrude out of the sleeve.

6. The media storage device according to claim 3, wherein the sleeve comprises a surface layer, a buffer layer and a base layer, the buffer layer is disposed between the surface layer and the base layer, the base layer is closer to the body and the heaters, and the surface layer is closer to the pressing roller.

7. The media storage device according to claim 1, wherein the heating resolution of the sectional heating module comprises 200 dpi, 300 dpi, 600 dpi and 1200 dpi.

8. A sectional image printing method comprising:
providing a sectional heating module and a pressing roller in contact with the sectional heating module;
forming an image on a piece of paper in advance;
causing the paper to pass through between the pressing roller and the sectional heating module, causing multiple heaters of the sectional heating module that are positioned in correspondence with the image to generate heat; and
causing the pressing roller and the sectional heating module to press against each other so that the image is fixed onto the paper.

9. The sectional image printing method according to claim 8, wherein any two adjacent ones of the heaters do not generate heat.

10. The sectional image printing method according to claim 8, wherein any two adjacent ones of the heaters generate heat.

11. The sectional image printing method according to claim 8, wherein one of any two adjacent ones of the heaters generates heat.

12. The sectional image printing method according to claim 8, wherein causing multiple heaters of the sectional heating module that are positioned in correspondence with the image to generate heat is conducted in such a manner that the heaters are each controlled by a corresponding power circuit.

13. The sectional image printing method according to claim 12, wherein the power circuits are controlled by a power controller.

14. The sectional image printing method according to claim 8, wherein the number of the heaters is determined based on a paper print resolution.
